(19) United States
(12) Patent Application Publication
(10) Pub. No.: US 2025/0358767 A1
(43) Pub. Date: Nov. 20, 2025

(54) METHOD AND APPARATUS FOR MANAGING NETWORK SLICE SELECTION ASSISTANCE INFORMATION LISTS IN A WIRELESS COMMUNICATION SYSTEM

(71) Applicant: Samsung Electronics Co., Ltd., Suwon-si (KR)

(72) Inventors: Lalith KUMAR, Bangalore (IN); Danish Ehsan HASHMI, Bangalore (IN)

(21) Appl. No.: 19/213,941

(22) Filed: May 20, 2025

(30) Foreign Application Priority Data
May 20, 2024 (IN) 202441039238
May 5, 2025 (IN) 202441039238

(51) Int. Cl. H04W 60/04; H04W 12/06; H04W 48/18; H04W 84/04

(52) U.S. Cl. CPC H04W 60/04; H04W 12/06; H04W 48/18; H04W 84/042

(57) ABSTRACT

The disclosure relates to a 5G or 6G communication system for supporting a higher data transmission rate. Embodiments herein disclose a method for managing network slice selection assistance information (NSSAI) list in a wireless communication network. The method includes receiving, by a user equipment (UE), at least one signaling message from a network function entity. The method further includes determining, by the UE, whether at least one allowed NSSAI list is received for a network entity from the at least one signaling message. The method further includes deleting, by the UE, a stored allowed NSSAI list and a partially allowed NSSAI list for the network entity on determining no allowed NSSAI list is received from the at least one signaling message.

### CROSS REFERENCE TO RELATED APPLICATIONS

This application is based on and derives the benefit of an Indian Provisional Patent application 202441039238(PS) filed on May 20, 2024, in the Indian Intellectual Property Office, and an Indian Complete patent application 202441039238(CS) filed on May 5, 2025, in the Indian Intellectual Property Office, the contents of each of which are incorporated herein by reference.

### BACKGROUND

### 1. Field

The disclosure relates to wireless communication systems. More particularly, the disclosure relates to methods and apparatus for managing network slice selection assistance information (NSSAI) lists in the wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure relates to wireless communication systems. More particularly, the disclosure relates to methods and apparatus for managing Network Slice Selection Assistance Information (NSSAI) lists in the wireless communication system.

According to an aspect of an exemplary embodiment, there is provided a communication method in a wireless communication system.

Aspects of the present disclosure provide efficient communication methods in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustrated drawings. Embodiments herein are illustrated by way of examples in the accompanying drawings, and in which:

FIG. 1 illustrates an example scenario for managing NSSAI list according to an embodiments as disclosed herein;

FIG. 2 illustrates a wireless network for 5th generation wireless communication according to various embodiments as disclosed herein;

FIG. 3 illustrates a wireless network for managing NSSAI lists in conjunction with FIG. 2 according to various embodiments as disclosed herein;

FIG. 4 illustrates a flowchart for a method for managing NSSAI list when an event occurs according to various embodiments as disclosed herein;

FIG. 5 illustrates a flowchart for a method for managing NSSAI list when the UE receives a new partially allowed NSSAI list according to various embodiments as disclosed herein;

FIG. 6 illustrates a wireless network for managing NSSAI lists from a perspective of the network function entity in conjunction with FIG. 2 according to various embodiments as disclosed herein;

FIG. 7 illustrates a flowchart for a method for managing NSSAI list from a perspective of the network entity according to various embodiments as disclosed herein;

FIG. 8 illustrates a sequence diagram for managing NSSAI list according to various embodiments as disclosed herein.

FIG. 9 illustrates a UE according to various embodiments of the present disclosure; and

FIG. 10 illustrates various hardware components of a network entity according to various embodiments as disclosed herein.

### DETAILED DESCRIPTION

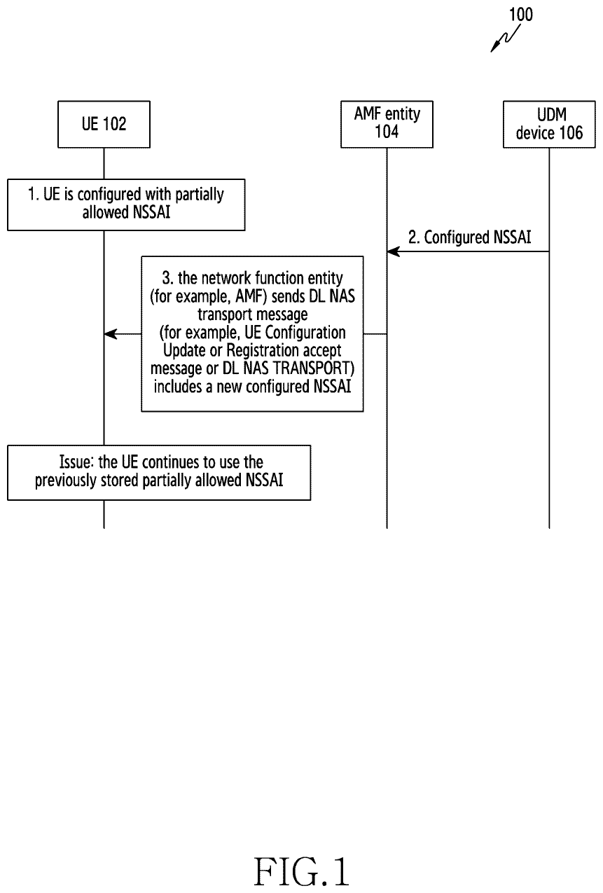

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments disclosed herein relate to a wireless communication network, and more particularly to the wireless communication network and a method for managing network slice selection assistance information (NSSAI) lists in the wireless communication network.

As described in 3rd Generation Partnership Project (3GPP) Technical Specification (TS) 24.501, if a user equipment (UE) has indicated that the UE supports a network slice replacement feature and an access and mobility management function (AMF) entity determines to provide a mapping information between a single network slice selection assistance information (S-NSSAI) to be replaced and an alternative S-NSSAI to the UE, a network entity may provide the UE with the alternative NSSAI. The alternative NSSAI is managed per access type independently, i.e., a 3GPP access type or a non-3GPP access type, and is applicable for a registration area. If the AMF entity determines that the S-NSSAI which has been replaced is available then, the AMF entity provides the updated alternative NSSAI excluding the S-NSSAI which has been replaced and the corresponding alternative S-NSSAI to the UE during a UE configuration update procedure or during a registration procedure. The AMF entity also provides the updated allowed NSSAI and configured NSSAI to the UE. If the UE has indicated that the UE supports a partial network slice feature and includes the S-NSSAI(s) in the requested NSSAI, the AMF entity determines the S-NSSAI(s) to be included in the partially allowed NSSAI or a partially rejected NSSAI. When the AMF entity provides both the partially allowed NSSAI and the partially rejected NSSAI to the UE, each S-NSSAI may be either in the partially allowed NSSAI or in the partially rejected NSSAI but not both.

Support for network slices with a network slice area of a service not matching deployed tracking areas: The network entity support for the network slice is defined on a per tracking area granularity. It may be beneficial to deploy some network slices such that the network slice has a limited geographical availability that is not matching with existing tracking area (TA) boundaries. A network operator can, in this case, decide to change a topology of the tracking areas so they match the boundaries of the network slice, or the network operator may configure resources for the network slices in the cells of TAs where the network slices are to be available, and in areas of the TAs where the network slice, defined to be not available the cells, are configured with zero resources. That is, if a network slice area of service (NS-AoS) includes TAs where the network slice is not available in some cells of the TA. In order to optimize the end-to-end behavior, the AMF entity can, based on NS-AoS information received from the OAM entity, configure supporting UEs with S-NSSAI location availability information, and a 5th generation core network may need to monitor the S-NSSAI usage and enforce the NS-AoS. That is, if the UE does not support the S-NSSAI location availability information. Then, the UE, that receives S-NSSAI location availability information, applies the information as follows:
a. If the S-NSSAI is rejected in the registration area (RA) or rejected partially in the RA or rejected with a cause code that allows attempting to register the S-NSSAI again, the UE can request the S-NSSAI only if the S-NSSAI location availability information indicates that the S-NSSAI is available at the cell where the UE is camping;
b. If the S-NSSAI is in the partially allowed NSSAI, the UE may not activate user plane for any already established protocol data unit (PDU) session with that S-NSSAI if the UE is in the cell within the RA but outside the location information of the S-NSSAI; and
c. If the S-NSSAI is in the partially allowed NSSAI, and the UE in CM-IDLE mode is moved to a cell outside the location information of the S-NSSAI, and the UE has an established PDU session with that S-NSSAI, the PDU Session is kept.

As per the prior art (or the existing methods), if the S-NSSAI not supported in entire Registration area or entire TA, the network entity may notify the UE in one of the NSSAI lists such as partially allowed NSSAI, (or) partially rejected NSSAI, (or) network slice area of service. If the S-NSSAI is replaced by an alternative S-NSSAI whether the UE is allowed to consider the S-NSSAI is allowed as per the NSSAI lists corresponding to alternative S-NSSAI or the one that is being replaced is not clear.

FIG. 1 illustrates an example scenario (100) for managing the NSSAI list, according to the prior art. In an example scenario, consider, the S-NSSAI to be replaced is a part of a partially allowed NSSAI list or a partially rejected NSSAI list or part of NS-AoS Information, and the UE 102 does not receive services in the area where the UE 102 is allowed to receive the services. At step 1, the UE 102 is configured with the partially allowed NSSAI. At step 2, due to update in subscription or any other reasons, a unified data management device (e.g., UDM device) 106 decides to update the configured NSSAI for the UE 102 and associated with mapped S-NSSAIs for PLMNs. The term configured NSSAI in the patent disclosure is at least one of the configured NSSAI, default configured NSSAI or mapped S-NSSAIs for PLMNs or configured NSSAI for the current PLMN or standalone non-public network (SNPN). A network function entity (for example, the AMF entity) 104 sends a downlink non-access stratum (DL NAS) transport message (for example, UE configuration update or registration accept message or DL NAS TRANSPORT) includes a new configured NSSAI for the UE 102. The UE 101 stores the related information including a new configured NSSAI for the UE 102. At step 3, the UE 102 continues to use the partially allowed NSSAI configured by the UE 102. When the UE 102 moves to an area, based on a new subscription, the UE 102 is allowed to receive the services but because the UE 102 continues to use the previously stored partially allowed NSSAI, the UE 102 may not be able to access the services.

Hence, there is a need in the art for solutions which may overcome the above-mentioned drawback(s), among others. The principal object of embodiments herein is to disclose systems (or wireless communication network) and methods for managing NSSAI lists in the wireless communication networks.

Another object of embodiments herein is to delete at least one of: a stored allowed NSSAI list and a partially allowed NSSAI list for the network entity on determining no allowed NSSAI list is received from the signaling message.

Another object of embodiments herein is to delete by the UE, a stored NSSAI list for the network entity on determining the partially allowed NSSAI list is received from a DL NAS transport message.

Accordingly, the embodiments herein provide a method for managing network slice selection assistance information (NSSAI) list in a wireless communication network. The method includes receiving, by a user equipment (UE), at least one signaling message from a network function entity. The method further includes deleting, by the UE, a stored partially allowed, when an event occurs, based on the at least one signaling message.

Accordingly, the embodiments herein provide a method for managing NSSAI list in a wireless communication network. The method includes receiving by a user equipment (UE), at least one signaling message from a network function entity. The method further includes determining by the UE, whether a new partially allowed NSSAI list for a current public land mobile network (PLMN) or a current standalone non-public network (SNPN) is received. The method further includes deleting by the UE, a single network slice selection assistance information (S-NSSAI(s)) from a part of the new partially allowed NSSAI list from a stored NSSAI list for the network entity on determining the new partially allowed NSSAI list for the current PLMN or SNPN is received from the network function entity as part of the signaling message.

Accordingly, the embodiments herein provide a method for managing network slice selection assistance information (NSSAI) list in a wireless communication network. The method includes sending by a network function entity, at least one signaling message to a user equipment (UE). The method further includes providing, by the network function entity, a partially allowed NSSAI list for a current public land mobile network (PLMN) or a current standalone non-public network (SNPN). The method further includes receiving by the network function entity, a response signaling message from the UE. The response signaling message comprises information about a single network slice selection assistance information (S-NSSAI(s)) part of the new partially allowed NSSAI list from stored NSSAI list which is deleted by the UE (202) for the network entity on determining the new partially allowed NSSAI list for the current PLMN or the current SNPN is received from the network function entity as part of the signaling message.

Accordingly, the embodiments herein provide a user equipment (UE), including a processor, a memory, a transceiver, and a network slice selection assistance information (NSSAI) list management controller. The NSSAI list management controller is coupled with the processor and memory. The NSSAI list management controller is configured to receive at least one signaling message from a network function entity. The NSSAI list management controller is configured to delete a stored partially allowed NSSAI list for the network entity, when an event occurs, based on the at least one signaling message.

Accordingly, the embodiments herein provide a user equipment (UE), including a processor, a memory, a transceiver, and a network slice selection assistance information (NSSAI) list management controller. The NSSAI list management controller is coupled with the processor and memory. The NSSAI list management controller is configured to receive at least one signaling message from a network function entity. The NSSAI list management controller is further configured to determine whether a partially allowed NSSAI list a current public land mobile network (PLMN) or a current standalone non-public network (SNPN) is received. The NSSAI list management controller is configured to delete a single network slice selection assistance information (S-NSSAI(s)) from a part of the new partially allowed NSSAI list from a stored NSSAI list for the network entity on determining the new partially allowed NSSAI list for the current PLMN or the SNPN is received from the network entity as part of the signaling message.

Accordingly, the embodiments herein provide a network function entity including a processor, a memory, a transceiver, and a network slice selection assistance information (NSSAI) list management controller. The NSSAI list management controller is coupled with the processor and memory. The NSSAI list management controller is configured to send at least one signaling message to a user equipment (UE). The NSSAI list management controller is further configured to provide a partially allowed NSSAI list for the for a current public land mobile network (PLMN) or a current standalone non-public network (SNPN). The NSSAI list management controller is further configured to receive a response signaling message from the UE, wherein the response signaling message comprises information about a single network slice selection assistance information (S-NSSAI(s)) part of the new partially allowed NSSAI list from stored NSSAI list which is deleted by the UE (202) for the network entity on determining the new partially allowed NSSAI list for the current PLMN or the current SNPN is received from the network function entity as part of the signaling message.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The following definitions and abbreviations have been referred to herein:
AMF: Access and Mobility Management Function;
DL: Downlink;
NAS: Non-Access Stratum;
NS-AoS: Network Slice Area of Service;
NSSAI: Network Slice Selection Assistance Information;
N3GPPA: Non 3GPP Access;
PDU: Packet Data Unit;
RA: Registration Area;
S-NSSAI: Single—Network Slice Selection Assistance Information;
SR: Service Request;
TA: Tracking Area;
TAI: Tracking Area Identity;
UL: Uplink;
UP: User Plane;
UPF: User Plane Function;
3GPP: 3^{rd} generation partnership project; and
3GPPA: 3GPP Access.

The term 5GMM sublayer states in this embodiment are at least one of the below:
1) 5GMM-NULL;
2) 5GMM-DEREGISTERED:
   a) 5GMM-DEREGISTERED.NORMAL-SERVICE,
   b) 5GMM-DEREGISTERED.LIMITED-SERVICE,
   c) 5GMM-DEREGISTERED.ATTEMPTING-REGISTRATION,
   d) 5GMM-DEREGISTERED.PLMN-SEARCH,
   e) 5GMM-DEREGISTERED.NO-SUPI,
   f) 5GMM-DEREGISTERED.NO-CELL-AVAILABLE,
   g) 5GMM-DEREGISTERED.eCALL-INACTIVE, and
   h) 5GMM-DEREGISTERED.INITIAL-REGISTRATION-NEEDED;
3) 5GMM-REGISTERED-INITIATED;
4) 5GMM-REGISTERED:
   a) 5GMM-REGISTERED.NORMAL-SERVICE,
   b) 5GMM-REGISTERED.NON-ALLOWED-SERVICE,
   c) 5GMM-REGISTERED.ATTEMPTING-REGISTRATION-UPDATE,
   d) 5GMM-REGISTERED.LIMITED-SERVICE,
   e) 5GMM-REGISTERED.PLMN-SEARCH,
   f) 5GMM-REGISTERED.NO-CELL-AVAILABLE, and
   g) 5GMM-REGISTERED.UPDATE-NEEDED;
5) 5GMM-DEREGISTERED-INITIATED; and
6) 5GMM-SERVICE-REQUEST-INITIATED.

5GMM-IDLE mode: In this specification, if the term is used standalone, a UE in 5GMM-IDLE mode means the UE can be either in 5GMM-IDLE mode over 3GPP access or in 5GMM-IDLE mode over non-3GPP access.

5GMM-CONNECTED mode: In this specification, if the term is used standalone, a UE in 5GMM-CONNECTED mode means the UE can be either in 5GMM-CONNECTED mode over 3GPP access or in 5GMM-CONNECTED mode over non-3GPP access.

5GMM-IDLE mode over 3GPP access: A UE is in 5GMM-IDLE mode over 3GPP access when no N1 NAS signaling connection between the UE and network over 3GPP access exists. The term 5GMM-IDLE mode over 3GPP access used in the present document corresponds to the term CM-IDLE state for 3GPP access used in 3GPP TS 23.501.

5GMM-CONNECTED mode over 3GPP access: A UE is in 5GMM-CONNECTED mode over 3GPP access when an N1 NAS signaling connection between the UE and network over 3GPP access exists. The term 5GMM-CONNECTED mode over 3GPP access used in the present document corresponds to the term CM-CONNECTED state for 3GPP access used in 3GPP TS 23.501.

Partially allowed NSSAI: indicating the S-NSSAIs values the UE could use in the serving PLMN or SNPN in some of the TAs in the current registration area. Each S-NSSAI in the partially allowed NSSAI is associated with a list of TAs where the S-NSSAI is supported.

Network slice area of service: The area where a UE can access and get service of a particular network slice as more than zero resources are allocated to the network slice in the NG-RAN cells.

S-NSSAI location availability information: The S-NSSAI location availability information sent to the UE includes, for each applicable S-NSSAI of the Configured NSSAI, Location information indicating the cells of TAs in the RA where the related S-NSSAI is available if the S-NSSAI is not available in all the cells of the TA:
Alternative NSSAI: A list of mapping information between the S-NSSAI to be replaced and the alternative S-NSSAI;
Partially rejected NSSAI: Indicating the S-NSSAI(s) is rejected by the network in some TA(s) but not all TAs of the registration area. Each S-NSSAI in the partially rejected NSSAI is associated with a list of TAs where the S-NSSAI is rejected; and
On-demand S-NSSAI: An S-NSSAI that the UE is allowed to be registered with the network only when this S-NSSAI is used by the UE to establish a PDU session for user data transmission.

The embodiments herein achieve systems and methods for managing network slice selection assistance information (NSSAI) lists in wireless communication networks there by UE is not expected to remain in no service. i.e., following this disclosure UE based on its knowledge of whether the S-NSSAI i.e., a service is allowed or not allowed in a given area can make request for the services appropriately.

In an embodiment, the UE may delete the stored partially allowed NSSAI and stored mapped S-NSSAI(s) for partially allowed NSSAI over 3GPP access when a CONFIGURATION UPDATE COMMAND message with the registration requested bit of the Configuration update indication IE set to “registration requested” is received and contains no other parameters or the REGISTRATION ACCEPT message is received with the “NSSAA to be performed” indicator of the 5GS registration result IE set to “Network slice-specific authentication and authorization is to be performed,” and the REGISTRATION ACCEPT message contains a pending NSSAI and no new partially allowed NSSAI.

In an embodiment, the network entity may provide the partially allowed NSSAI to the UE, when a new partially allowed NSSAI for a PLMN or SNPN is received. The network entity removes, from the stored rejected NSSAI for the current PLMN or SNPN, the rejected NSSAI for the current registration area, rejected NSSAI for the maximum number of UEs reached and the partially rejected NSSAI, the S-NSSAI(s), if any, included in the new partially allowed NSSAI for the current PLMN or SNPN. The network entity, removes from the stored rejected NSSAI for the failed or revoked NSSAA, the S-NSSAI(s), if any, included in the new partially allowed NSSAI optionally for the current PLMN (optionally if the UE is not roaming) or the current SNPN (if the SNPN is the subscribed SNPN) or the current SNPN (if the SNPN is a non-subscribed SNPN). The network entity removes from the stored pending NSSAI for this PLMN and its equivalent PLMN(s) in the registration area or this SNPN, one or more S-NSSAIs, if any, included in the new partially allowed NSSAI for the current PLMN and these equivalent PLMN(s) (if the UE is not roaming) or the current SNPN (if the SNPN is the subscribed SNPN) or the current SNPN (if the SNPN is a non-subscribed SNPN).

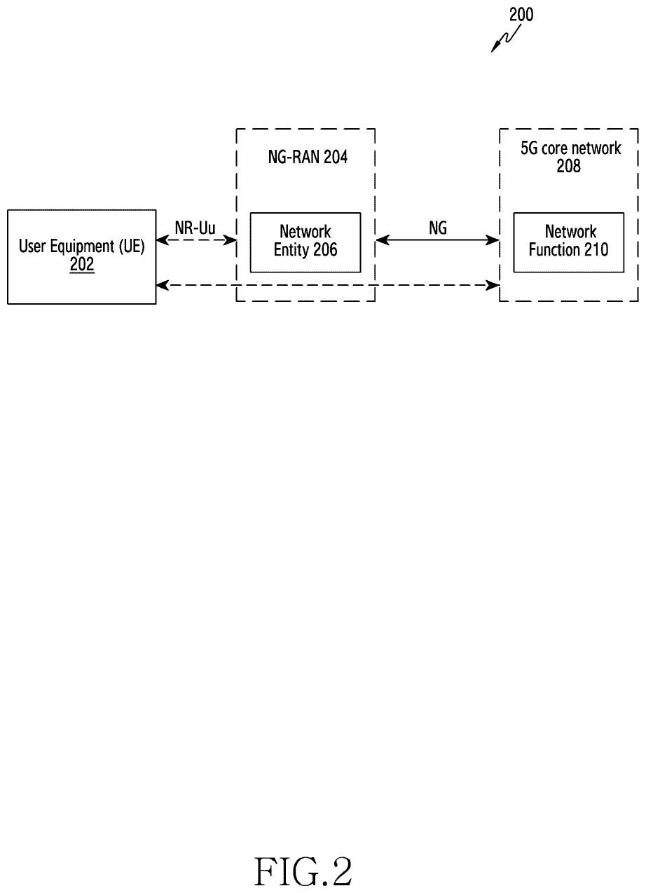

Referring now to the drawings, and more particularly to FIGS. 2 through 8, where similar reference characters denote corresponding features consistently throughout the figures, there are shown embodiment.

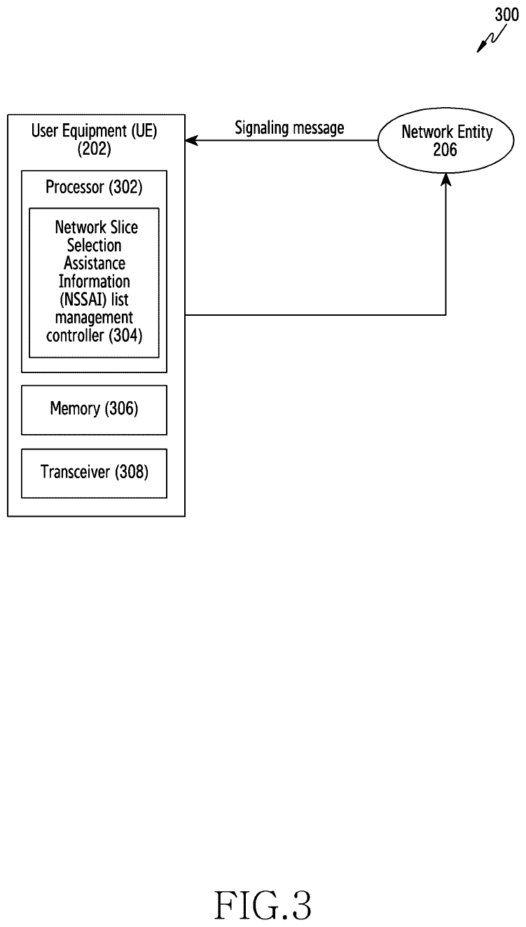

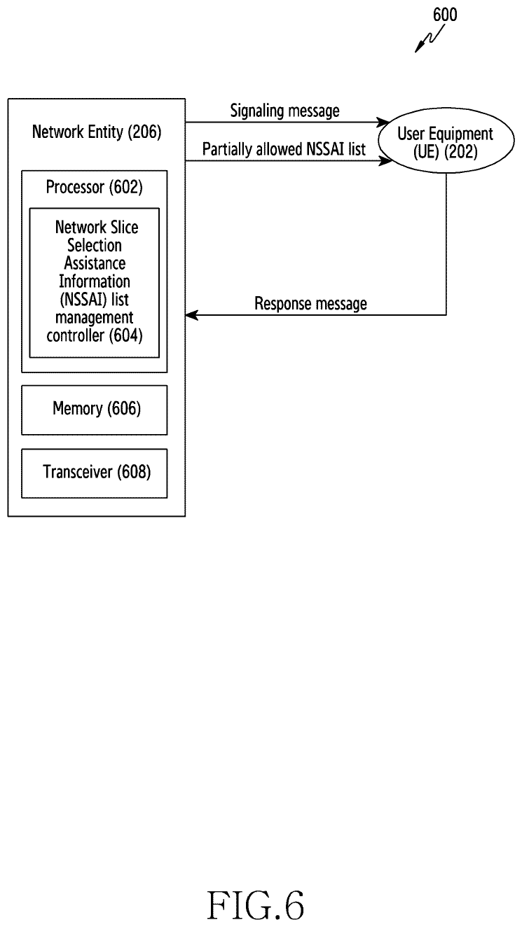

FIG. 2 illustrates a wireless network 200 for 5th generation wireless communication according to various embodiments as disclosed herein. Schematically, The wireless network 200 (e.g., 5G system or the like) includes a user equipment (UE) 202, composed of a mobile station and a universal subscriber identity module (USIM), a radio access network (NG-RAN) 204 and a core network (5GC) 208, as shown in the FIG. 2. The main entity of the NG-RAN is a network entity 206. For example, the network entity 206 may be, but is not limited to, a public land mobile network (PLMN) and a standalone non-public network (SNPN). The PLMN is a public cellular network operated by a mobile network operator (MNO) to provide wireless communication services to subscribers (or the user(s) or consumers). The SNPN is a private 5G network that operates independently of public mobile networks, designed for exclusive use by specific organizations such as factories, airports, or campuses or the like. The radio interface is named “NR-Uu” indicated by “NR” (for “new radio”) and Uu refers to the radio interface (or air interface) between the user equipment (UE) 202 and the network entity 206. The 5GC 208 includes network function entities. The 5GC 208 relies on a “service-based architecture” (SBA) framework, where the architecture elements are defined in terms of “network function entities” (NFs) 210. Via interfaces of a common framework, any given network function entity 210 offers services to all the other authorized NFs 210 and/or to any “consumers” or the subscribers that are permitted to make use of these provided services. The network function entity 210 includes, but is not limited to an access and mobility management function (AMF), a user plane function (UPF) entity, a unified data management entity and other network function entities. The UPF entity handles user data and, in a signaling plane, the AMF accesses the UE 202 and the (R)AN, and the UDM entity communicates with other NFs over service-based interfaces (SBI). The UDM entity provides information like subscription data, policy information, and authentication credentials. The reference point between the access and the core networks is called “NG.” This reference point is constituted of several interfaces (mostly N2, N3). In embodiments as disclosed herein, the network function entity 210 may send a signaling message to the UE 202. The signaling message may be a downlink non-access stratum (DL NAS) message. Further, the functions and operations of the UE 202 and the network entity 206 is explained in FIG. 3. Further, the functions and operations of the UE 202 and the network function 210 is explained in FIG. 6.

FIG. 3 illustrates the wireless network 300 for managing the NSSAI lists in conjunction with FIG. 2 according to various embodiments as disclosed herein. The wireless network 300 can be, for example, but not limited to a fourth-generation (4G) wireless network, a fifth-generation (5G) wireless network, an open radio access network (ORAN), a sixth generation (6G) network or the like. The wireless network 300 includes one or more UEs 202 and one or more network function entity 210. The network function entity 210 may be, for example, the access and mobility management function (AMF) entity and the UDM device. The UE 202 may be, for example, but not limited to a laptop, a smart phone, a desktop computer, a notebook, a device-to-device (D2D) device, a vehicle to everything (V2X) device, a foldable phone, a smart TV, a tablet, a television, a connected car, an immersive device, an internet of things (IoT) device, or any other device that can communicate using the wireless network.

In an embodiment herein, the UE 202 comprises a processor 302, a network slice selection assistance information (NSSAI) list management controller 304, a memory 306, and a transceiver 308. In an embodiment herein, the NSSAI list management controller 304 is a part of the processor 302, where the NSSAI list management controller 304 communicates with the network entities 206 through the transceiver 308. In another embodiment herein, the NSSAI list management controller 304 is outside the processor 302 but the NSSAI list management controller 304 is in communication with the processor 302, where the NSSAI list management 304 communicates with the network entity 206 through the transceiver 208. In another embodiment herein, the NSSAI list management controller 304 is outside the processor 302, and the NSSAI list management controller 304 works separately from the processor 302, where the NSSAI list management controller 304 communicates with the network entities 206 through the transceiver 308.

In an embodiment herein, the memory 306 is configured to store instructions to be executed by the processor 302. The memory 306 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 306 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory 306 is configured to store larger amounts of information. In certain examples, a non-transitory storage medium may store data that can, over time, change (e.g., in random access memory (RAM) or cache).

The processor 302 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 302 may include multiple cores and is configured to execute the instructions stored in the memory 306.

In an embodiment, the transceiver 308 includes an electronic circuit specific to a standard that enables wired or wireless communication. The transceiver 308 is configured to communicate internally between internal hardware components of the UE 202 and with external devices via one or more networks.

In an embodiment herein, the S-NSSAI may be replaced. The S-NSSAI may be a part of: a partially allowed NSSAI list, a partially rejected NSSAI list, or a part of network slice—availability of slice (NS_AOS) Information. The UE 202 may contain a configured partially allowed NSSAI or a stored partially allowed NSSAI list. Due to update in subscription or any other reasons, the network function entity 210 decides to update the configured NSSAI list for the UE 202, and an associated mapped S-NSSAIs for the given network entity 206 in a registration area or a tracking area. The term configured NSSAI in this embodiment may include at least one of the configured NSSAI, default configured NSSAI or mapped S-NSSAIs for the network entity 206. The UE 202 may receive a signaling message from the network function entity 210.

In an embodiment herein, the signaling message may be the DL NAS transport message. The DL NAS message may include for example, a UE configuration update command message, a registration accept message, or a DL NAS TRANSPORT message. In an embodiment herein, the signaling message may include a new configured NSSAI list for the UE 202.

In an embodiment herein, the UE 202 may delete the stored partially allowed NSSAI list when at least one event occurs in the received signaling message. The at least one event may be a received configuration update command message may include “no other parameters,” containing a configuration update indication information element (IE) set to “registration requested.” When the UE 202 determines that there is no other parameter other than the at least one configuration update indication information element (IE) set to “registration requested” received in the signaling message, the UE 202 may delete the stored partially allowed NSSAI list.

In an embodiment herein, the at least one event may be a registration accept message is received from the network function entity 210. The registration accept message may include a “network slice-specific authentication and authorization (NSSAA) to be performed” indicator of the 5GS registration result IE set to “network slice-specific authentication and authorization is to be performed” and the registration accept message may contain at least one of: a pending NSSAI list, and no new partially allowed NSSAI list.

In an embodiment herein, the UE 202 may determine that no new NSSAI list is received in the signaling message from the network function entity 210. Further, there may be no new allowed NSSAI list or no new partially allowed NSSAI list in the signaling message.

In an embodiment when no new allowed NSSAI list is received from the at least one signaling message, the NSSAI list management controller 304 deletes the previously stored allowed NSSAI list and the partially allowed NSSAI list for the network entity 206.

In an embodiment herein, the NSSAI list management controller 304 receives a new configured NSSAI list for the network entity 206 from the network function entity 210. The NSSAI list management controller 304 determines whether the configuration update indication IE with the registration requested bit set to “registration requested,” and whether any new allowed NSSAI list is included for a given network entity 206 in the same configuration update command message. For example, the UE 202 may determine whether a new partially allowed NSSAI list for a current public land mobile network (PLMN) or a current standalone non-public network (SNPN) is received. The NSSAI list management controller 304 may delete a single network slice selection assistance information (S-NSSAI(s)) part of the new partially allowed NSSAI list from a stored NSSAI list for the network entity on determining the new partially allowed NSSAI list for the current PLMN or SNPN is received from the network function entity as part of the signaling message. That is, when the UE is provisioned with a new configured NSSAI for a PLMN or SNPN, the UE may delete any stored allowed NSSAI and partially allowed NSSAI for this PLMN or SNPN and, if available, the stored mapped S-NSSAI(s) for the allowed NSSAI, if the UE received the new configured NSSAI for this PLMN or SNPN and the configuration update indication IE with the registration requested bit set to “registration requested,” in the same CONFIGURATION UPDATE COMMAND message but without any new allowed NSSAI for this PLMN or SNPN included.

In an example herein, the UE 202 deletes the stored partially allowed NSSAI list optionally for the given PLMN or SNPN. The UE 202 deletes the stored mapped partially allowed NSSAI list optionally for the given PLMN or SNPN. Similarly, if the UE 202 receives a default configured NSSAI list or mapped S-NSSAIs for PLMNs or configured NSSAI list for the PLMN or SNPN, the UE 202 deletes the partially allowed NSSAI list from the memory 306 of the UE. The deletion of partially allowed NSSAI list can be per PLMN or per access type or 3GPP access only.

In another example herein, if at least one of: a new partially allowed NSSAI list, a rejected NSSAI list, a partially rejected NSSAI list is received by the UE 202 for the PLMN then the UE 202 removes the stored pending NSSAI list optionally for the PLMN and its equivalent PLMN(s) in the registration area. If at least one of: the new partially allowed NSSAI list, the rejected NSSAI list, the partially rejected NSSAI list is received by the UE 202 for the SNPN then, the UE 202 removes the stored pending NSSAI list optionally for the SNPN in the registration area. The UE 202 removes the stored pending one or more S-NSSAIs, if any, included in the new partially allowed NSSAI list, the rejected NSSAI list, the partially rejected NSSAI list optionally for the current PLMN and these equivalent PLMN(s) (if the UE is not roaming). The UE 202 removes the stored pending one or more S-NSSAIs, if any, included in the new partially allowed NSSAI list, the rejected NSSAI list, the partially rejected NSSAI list optionally for the current SNPN (if the SNPN is the subscribed SNPN). The UE 202 removes the stored pending mapped S-NSSAI(s) for the new partially allowed NSSAI list, the rejected NSSAI list, and the partially rejected NSSAI list optionally for the current PLMN and these equivalent PLMN(s) (if the UE is roaming) or the current SNPN (if the SNPN is a non-subscribed SNPN).

In one embodiment herein, when the UE 202 is provisioned with a new configured NSSAI list for the network entity 206, the UE 202 may delete any S-NSSAI(s) part of the new partially allowed NSSAI list from a stored NSSAI list for the network entity on determining the new partially allowed NSSAI list for the current PLMN or SNPN is received from the network function entity as part of the signaling message.

In an embodiment herein, the NSSAI list management controller 304 of the UE 202 may determine that the UE 202 has received a new partially allowed NSSAI list for the PLMN or SNPN in the signaling message.

In an embodiment herein, the NSSAI list management controller 304 of the UE 202 on determining the new partially allowed NSSAI list for network entity 206, the NSSAI list management controller 304 may delete the stored (S-NSSAI(s)) part of the new partially allowed NSSAI list from a stored NSSAI list for the network entity 206. The stored NSSAI list may be at least one of: the stored rejected NSSAI list, the stored rejected NSSAI list for the failed or revoked NSSAA, and the stored pending NSSAI list for the network entity 206 and its equivalent network entity(s) 206 in the registration area. the NSSAI list management controller 304 may delete one or more S-NSSAIs, if any S-NSSAIs is received in the signaling message.

In an embodiment herein, the stored NSSAI list comprises at least one of: at least one rejected NSSAI for a current public land mobile network (PLMN) or a current standalone non-public network (SNPN), a rejected NSSAI for a current registration area, and a rejected NSSAI for a maximum number of the UEs reached, and partially rejected NSSAI.

In an embodiment herein, the UE may delete the S-NSSAI(s) part of the new partially allowed NSSAI list from a stored rejected NSSAI for a failed or a revoked network slice-specific authentication and authorization (NSSAA), and the S-NSSAI(s) included in the new partially allowed NSSAI for at least one of: the current PLMN when the UE is not roaming and a current SNPN is a subscribed SNPN.

In an embodiment herein, the UE may delete the S-NSSAI(s) part of the new partially allowed NSSAI list from the stored pending NSSAI for at least one of: the current PLMN and its equivalent PLMN(s) in the registration area and the current SNPN when the UE is not roaming or the current SNPN is a subscribed SNPN.

In an example, the stored NSSAI list may include at least one of: at least one rejected NSSAI list for a current public land mobile network (PLMN) or a current standalone non-public network (SNPN), at least one rejected NSSAI list for a current registration area, and at least one rejected NSSAI list for a maximum number of the UEs reached, and at least one partially rejected NSSAI list and at least one single network slice selection assistance information (S-NSSAI(s)) included in the new partially allowed NSSAI list for the current PLMN or SNPN.

In an example, the stored NSSAI list may include at least one of: at least one: pending NSSAI list for at least one of: the current PLMN and its equivalent PLMN(s) in the registration area and the current SNPN, at least one S-NSSAIs the new partially allowed NSSAI list for the current PLMN when the UE is not roaming or the current SNPN when the SNPN is a subscribed SNPN, at least one mapped S-NSSAI(s) for the new partially allowed NSSAI list for the current PLMN and the equivalent PLMN(s) when the UE is roaming, and at least one mapped S-NSSAI(s) for the new partially allowed NSSAI list for the current SNPN when the SNPN is a non-subscribed SNPN.

In an example, the stored NSSAI list may include at least one of: at least one stored rejected NSSAI list for the failed or revoked Network slice-specific authentication and authorization (NSSAA), the S-NSSAI(s) included in the new partially allowed NSSAI list for at least one of: the current PLMN when the UE 202 is not roaming, and the S-NSSAI(s) included in the new partially allowed NSSAI list for a current SNPN when the SNPN is a subscribed SNPN. The network may provide to the UE the partially allowed NSSAI. When a new partially allowed NSSAI for a PLMN or SNPN is received and the new partially allowed NSSAI includes one or more S-NSSAI(s), the UE may remove from the stored rejected NSSAI for the current PLMN or SNPN, the rejected NSSAI for the current registration area, rejected NSSAI for the maximum number of UEs reached and the partially rejected NSSAI, the S-NSSAI(s), if any, included in the new partially allowed NSSAI for the current PLMN or SNPN

The network may provide to the UE the partially allowed NSSAI. When a new partially allowed NSSAI for a PLMN or SNPN is received and the new partially allowed NSSAI includes one or more S-NSSAI(s), the UE may remove from the stored rejected NSSAI for the failed or revoked NSSAA, the S-NSSAI(s), if any, included in the new partially allowed NSSAI for the current PLMN (if the UE is not roaming) or the current SNPN (if the SNPN is the subscribed SNPN)

The network may provide to the UE the partially allowed NSSAI. When a new partially allowed NSSAI for a PLMN or SNPN is received and the new partially allowed NSSAI includes one or more S-NSSAI(s), the UE may remove from the stored pending NSSAI for this PLMN and its equivalent PLMN(s) in the registration area or this SNPN, one or more S-NSSAIs, if any, included in the new partially allowed NSSAI for the current PLMN and these equivalent PLMN(s) (if the UE is not roaming) or the current SNPN (if the SNPN is the subscribed SNPN) or the mapped S-NSSAI(s) for the new partially allowed NSSAI for the current PLMN and these equivalent PLMN(s) (if the UE is roaming) or the current SNPN (if the SNPN is a non-subscribed SNPN).

When the UE is provisioned with a new configured NSSAI for a PLMN or SNPN, the UE may delete any stored allowed NSSAI and partially allowed NSSAI for this PLMN or SNPN and, if available, the stored mapped S-NSSAI(s) for the allowed NSSAI, if the UE received the new configured NSSAI for this PLMN or SNPN and the configuration update indication IE with the registration requested bit set to “registration requested,” in the same CONFIGURATION UPDATE COMMAND message but without any new allowed NSSAI for this PLMN or SNPN included.

The UE may delete the stored partially allowed NSSAI and stored mapped S-NSSAI(s) for partially allowed NSSAI over 3GPP access when the CONFIGURATION UPDATE COMMAND message with the registration requested bit of the configuration update indication IE set to “registration requested” is received and contains no other parameters:

The UE may delete the stored partially allowed NSSAI and stored mapped S-NSSAI(s) for partially allowed NSSAI over 3GPP access when the REGISTRATION ACCEPT message is received with the “NSSAA to be performed” indicator of the 5GS registration result IE set to “network slice-specific authentication and authorization is to be performed,” and the REGISTRATION ACCEPT message contains a pending NSSAI and no new partially allowed NSSAI.

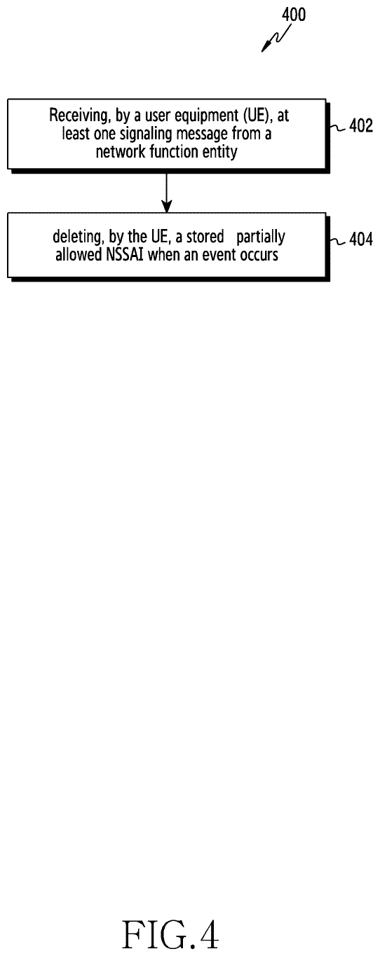

FIG. 4 illustrates a flowchart for a method 400 for managing NSSAI list when an event occurs according to various embodiments as disclosed herein. At step 402, the NSSAI list management controller 304 may receive the signaling message from the network function entity 210. The signaling message may be the downlink non-access stratum (DLNAS) transport message. The DL NAS message may include for example, the UE configuration update command message, the registration accept message, or the DL NAS TRANSPORT message. At step 404, the NSSAI list management controller 304 deletes the previously stored partially allowed NSSAI list for the network entity 206, when the event occurs, based on the at least one signaling message.

The event may occur when the configuration update command message may include no other parameter other than at least one of a registration requested bit, containing a configuration update indication information element (IE) set to “registration requested.” In an embodiment herein, the event may occur when the registration accept message is received from the network function entity 210. The registration accept message may include a “network slice-specific authentication and authorization (NSSAA) to be performed” indicator of the 5GS registration result IE set to “network slice-specific authentication and authorization is to be performed” and the registration accept message may contain at least one of: a pending NSSAI list, and no new partially allowed NSSAI list. The NSSAI list management controller 304 deletes the previously stored partially allowed NSSAI list no new NSSAI list is received in the signaling message from the network function entity 210. There may be no new allowed NSSAI list or no new partially allowed NSSAI list in the signaling message.

The various actions in method 400 may be performed in the order presented, in a different order or simultaneously. Further, in some embodiments, some actions listed in FIG. 4 may be omitted.

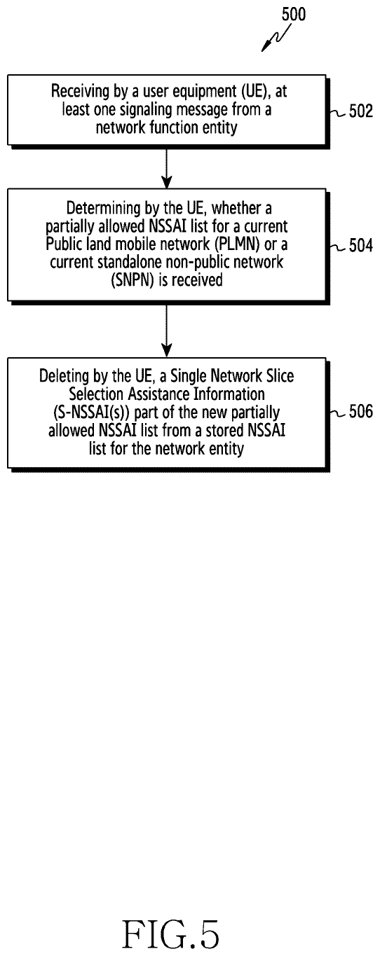

FIG. 5 illustrates a flowchart for a method 500 for managing NSSAI list when the UE receives a new partially allowed NSSAI list according to various embodiments as disclosed herein. At step 502, the NSSAI list management controller 304 may receive the signaling message from the network function entity 210. The signaling message may be a downlink non-access stratum (DL NAS) transport message. The DL NAS message may include for example, a UE configuration update command message, a registration accept message, or a DL NAS TRANSPORT message. At step 504, the NSSAI list management controller 304 determines whether the at least one partially allowed NSSAI list is received from the network function entity 206 in the signaling message. The NSSAI list management controller 304 may determine that there is a new partially allowed NSSAI list configured in the signaling message for the current public land mobile network (PLMN) or the current standalone non-public network (SNPN). At step 506, the NSSAI list management controller 304 may delete a single network slice selection assistance information (S-NSSAI(s)) part of the new partially allowed NSSAI list from a stored NSSAI list for the network entity on determining the new partially allowed NSSAI list for the current PLMN or SNPN is received from the network function entity as part of the signaling message. The stored NSSAI list may be at least one of: a stored rejected NSSAI list, a stored rejected NSSAI for the failed or revoked NSSAA, and a stored pending NSSAI for the network entity 206 and its equivalent network entity(s) 206 in the registration area and one or more S-NSSAIs, if any in the signaling message.

The various actions in method 500 may be performed in the order presented, in a different order or simultaneously. Further, in some embodiments, some actions listed in FIG. 5 may be omitted.

FIG. 6 illustrates a wireless network 600 for managing NSSAI lists from a perspective of the network function entity in conjunction with FIG. 2 according to various embodiments as disclosed herein.

In an embodiment herein, the network function entity 210 comprises a processor 602, a network slice selection assistance information (NSSAI) list management controller 604, a transceiver 608, and a memory 606. In an embodiment herein, the NSSAI list management controller 604 is a part of the processor 602, where the NSSAI list management controller 604 communicates with the network entities 206 through the transceiver 608. In another embodiment herein, NSSAI list management controller 604 is outside the processor 602 but NSSAI list management controller 604 is in communication with the processor 602, where the NSSAI list management 604 communicates with the network entity 206 through the transceiver 608. In another embodiment herein, NSSAI list management controller 604 is outside the processor 602, and the NSSAI list management controller 604 works separately from the processor 602, where the NSSAI list management controller 604 communicates with the network entities 206 through the transceiver 608.

In an embodiment herein, the memory 606 is configured to store instructions to be executed by the processor 602. The memory 606 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 606 may, in some examples, be considered a non-transitory storage medium. The term “non-transitory” may indicate that the storage medium is not embodied in a carrier wave or a propagated signal. However, the term “non-transitory” should not be interpreted that the memory is non-movable. In some examples, the memory 606 is configured to store larger amounts of information. In certain examples, a non-transitory storage medium may store data that can, over time, change (e.g., in random access memory (RAM) or cache).

The processor 602 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 602 may include multiple cores and is configured to execute the instructions stored in the memory 606.

In an embodiment, the transceiver 608 includes an electronic circuit specific to a standard that enables wired or wireless communication. The transceiver 608 is configured to communicate internally between internal hardware components of the UE 202 and with external devices via one or more networks.

In an embodiment herein, the network function entity 210 may send at least one signaling message to the UE 202. The signaling message may be the downlink non-access stratum (DL NAS) transport message. The DL NAS message may include for example, the UE configuration update command message, the registration accept message, or the DL NAS TRANSPORT message.

In an embodiment herein, the network function entity 210 provides the partially allowed NSSAI list for the current PLMN or the current SNPN in the signaling message.

In an embodiment herein, the network function entity 210 receives a response signaling message from the UE 202. The response signaling message may include information about the S-NSSAI(s) part of the new partially allowed NSSAI list from stored NSSAI list which is deleted by the UE (202) for the network entity on determining the new partially allowed NSSAI list for the current PLMN or the current SNPN is received from the network function entity as part of the signaling message.

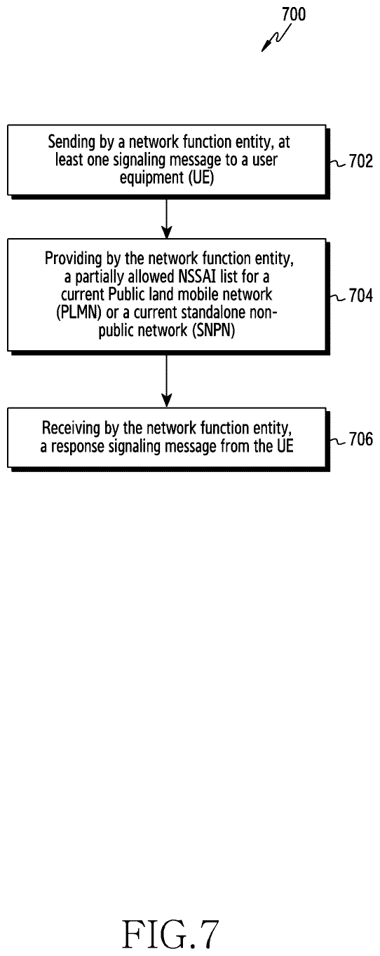

FIG. 7 illustrates a flowchart for a method for managing NSSAI list from a perspective of the network entity according to various embodiments as disclosed herein. At step 702, the network function entity 210 may send at least one signaling message to the UE 202. The signaling message may be the downlink non-access stratum (DL NAS) transport message. The DL NAS message may include for example, the UE Configuration Update Command message, the registration accept message, or the DL NAS TRANSPORT message. At step 704, the network function entity 210 provides the partially allowed NSSAI list for the current PLMN or the current SNPN in the signaling message. At step 706, the network function entity 210 receives a response signaling message from the UE 202. The response signaling message may include information about a S-NSSAI(s) part of the new partially allowed NSSAI list from stored NSSAI list which is deleted by the UE (202) for the network entity on determining the new partially allowed NSSAI list for the current PLMN or the current SNPN is received from the network function entity as part of the signaling message.

The various actions in method 700 may be performed in the order presented, in a different order or simultaneously. Further, in some embodiments, some actions listed in FIG. 7 may be omitted.

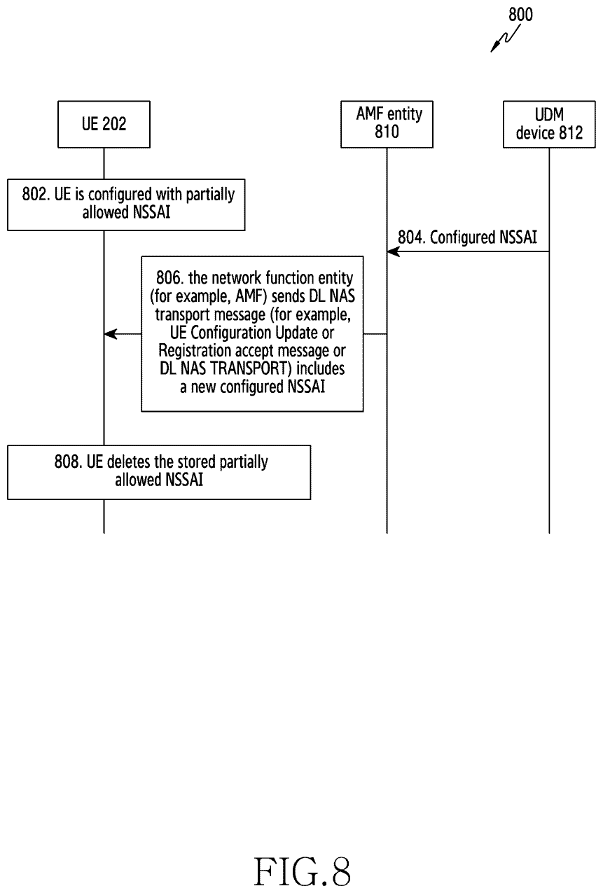

FIG. 8 illustrates an example sequence diagram for managing NSSAI list according to various embodiments as disclosed herein. FIG. 8 depicts a scenario, wherein the S-NSSAI to be replaced is part of the partially allowed, the partially rejected NSSAI list or part of NS_AOS information. At step 802, the UE 202 is configured with and has a stored partially allowed NSSAI list. At step 804, due to update in subscription or any other reasons, the UDM device 812 decides to update the configured NSSAI list for the UE 202, and associated with mapped S-NSSAIs for the PLMNs. The UDM 812 is the network function entity 210 here. The term configured NSSAI in the embodiment is at least one of the configured NSSAI list, default configured NSSAI list or mapped S-NSSAIs for PLMNs or configured NSSAI list for the PLMN or the SNPN. At step 806, the network function entity (for example, AMF entity 810) sends the DL NAS transport message (for example, UE configuration update or registration accept message or DL NAS TRANSPORT) includes a new configured NSSAI list for the UE 202. The UE 202 stores the related information. At step 808, the UE 202 deletes the stored partially allowed NSSAI list optionally for the PLMN or SNPN, mapped partially allowed NSSAI list optionally for the PLMN or SNPN. Similarly, if the UE 202 receives default configured NSSAI list or mapped S-NSSAIs for PLMNs or configured NSSAI list for the PLMN or SNPN, the UE 202 deletes the partially allowed NSSAI list from the UEs storage. The deletion of partially allowed NSSAI list can be per PLMN or per(the) access type or 3GPP access only.

In an embodiment herein, if the CONFIGURATION UPDATE COMMAND message is initiated only due to changes to the allowed NSSAI list or the partially allowed NSSAI list and these changes require the UE 202 to initiate a registration procedure, but the AMF is unable to determine the allowed NSSAI list or the partially allowed NSSAI list for the UE 202 as specified in 3GPP TS 23.501, then the CONFIGURATION UPDATE COMMAND message may indicate “registration requested” in the registration requested bit of the configuration update indication IE, and may not contain any other parameters.

The CONFIGURATION UPDATE COMMAND message is sent to the UE 202 optionally including configuration update indication IE with the registration requested bit set to “registration requested,” in the same CONFIGURATION UPDATE COMMAND message but without any new allowed NSSAI list or the partially allowed NSSAI list optionally for the PLMN or SNPN then UE 202 may delete the partially allowed NSSAI list.

If the CONFIGURATION UPDATE COMMAND message is initiated only due to changes to the allowed NSSAI list, the partially allowed NSSAI list, the rejected NSSAI list, and the partially rejected NSSAI and optionally these changes require the UE 202 to initiate a registration procedure, and optionally the AMF is unable to determine the allowed NSSAI list, the partially allowed NSSAI list the rejected NSSAI list, and the partially rejected NSSAI list for the UE 202 as specified in 3GPP TS 23.501, then the CONFIGURATION UPDATE COMMAND message may indicate “registration requested” in the registration requested bit of the configuration update indication IE, and may not contain any other parameters.

The CONFIGURATION UPDATE COMMAND message is sent to the UE optionally including configuration update indication IE with the registration requested bit set to “registration requested,” in the same CONFIGURATION UPDATE COMMAND message but without any new allowed NSSAI list, the partially allowed NSSAI list, the rejected NSSAI list, and partially rejected NSSAI list optionally for the PLMN or SNPN then UE 202 may delete the partially allowed NSSAI list and the partially rejected NSSAI list.

In an embodiment herein, when the new partially allowed NSSAI list, the rejected NSSAI list, or the partially rejected NSSAI list is received by the UE 202 then the UE 202 removes the stored pending NSSAI list optionally for the PLMN and its equivalent PLMN(s) in the registration area or the SNPN. The UE 202 removes one or more stored S-NSSAIs, if any, included in the new partially allowed NSSAI list, the rejected NSSAI list, and the partially Rejected NSSAI list optionally for the current PLMN and these equivalent PLMN(s) (if the UE is not roaming) or the current SNPN (if the SNPN is the subscribed SNPN). The UE 202 removes the mapped S-NSSAI(s) for the new partially allowed NSSAI list, the rejected NSSAI list, the partially rejected NSSAI list optionally for the current PLMN and the equivalent PLMN(s) (if the UE is roaming) or the current SNPN (if the SNPN is a non-subscribed SNPN).

In an embodiment herein, if the UE 202 deletes the allowed NSSAI list (for any of the triggers as specified in TS 24.501) then UE 202 may delete the partially allowed NSSAI list.

In an embodiment herein, if the UE 202 deletes the rejected NSSAI list (for any of the triggers as specified in TS 24.501) then UE 202 may delete the partially rejected NSSAI list.

In an embodiment herein, the rejected NSSAI list and the extended rejected NSSAI list IE are used interchangeably and have the same meaning.

In an embodiment herein, when the UE 202 is provisioned with a new configured NSSAI list for a PLMN or SNPN, the UE may delete any stored partially allowed NSSAI list.

The network may provide, to the UE 202, the partially allowed NSSAI list. When a new partially allowed NSSAI list for a PLMN or SNPN is received, the UE 202 may perform the following operations:
a) Remove from the stored rejected NSSAI list for the current PLMN or SNPN, the rejected NSSAI list for the current registration area, rejected NSSAI list for the maximum number of UEs reached and the partially rejected NSSAI list, the S-NSSAI(s), if any, included in the new partially allowed NSSAI list for the current PLMN or SNPN;
b) Remove from the stored rejected NSSAI list for the failed or revoked NSSAA, the S-NSSAI(s), if any, included in the new partially allowed NSSAI list optionally for the current PLMN (optionally if the UE is not roaming) or the current SNPN (if the SNPN is the subscribed SNPN) or the current SNPN (if the SNPN is a non-subscribed SNPN); and
c) Remove from the stored pending NSSAI list for the PLMN and its equivalent PLMN(s) in the registration area or the SNPN, one or more S-NSSAIs, if any, included in the new partially allowed NSSAI list for the current PLMN and these equivalent PLMN(s) (if the UE is not roaming) or the current SNPN (if the SNPN is the subscribed SNPN) or the current SNPN (if the SNPN is a non-subscribed SNPN).

In an embodiment herein, the UE 202 may delete any stored partially allowed NSSAI list for the PLMN and its equivalent PLMN(s) in the registration area or the SNPN via the 3GPP access, when the UE 202 receives the below triggers:
a) The UE 202 may delete any stored partially allowed NSSAI list for the PLMN and its equivalent PLMN(s) in the registration area or the SNPN via the 3GPP access when the UE 202 receives CONFIGURATION UPDATE COMMAND message (or any other NAS message) with the registration requested bit of the configuration update indication IE set to “registration requested” is received and contains no other parameters; and
b) The UE 202 may delete any stored partially allowed NSSAI list for the PLMN and its equivalent PLMN(s) in the registration area or the SNPN via the 3GPP access when the UE 202 receives the REGISTRATION ACCEPT message (or any other NAS message) is received with the “NSSAA to be performed” indicator of the 5GS registration result IE set to “network slice-specific authentication and authorization is to be performed,” and the REGISTRATION ACCEPT message contains a pending NSSAI list and no new partially allowed NSSAI list is received.

The IE names in the embodiment are only for illustration, the name can be any IE name during the implementation.

The embodiments disclosed herein can be implemented through at least one software program running on at least one hardware device and performing network management functions to control the network elements. The elements include blocks which can be at least one of a hardware device, or a combination of hardware device and software module.

The various actions in method 800 may be performed in the order presented, in a different order or simultaneously. Further, in some embodiments, some actions listed in FIG. 8 may be omitted.

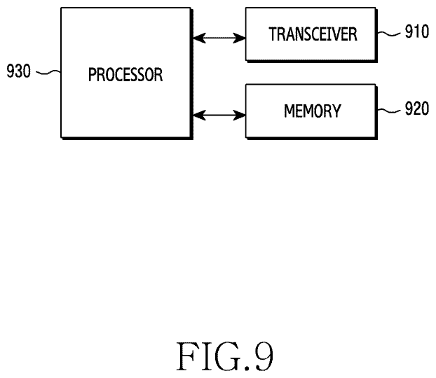

FIG. 9 illustrates a UE according to various embodiments of the present disclosure.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor. Furthermore, the UE of FIG. 9 corresponds to the UE referred to above according to various embodiments of the present disclosure.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

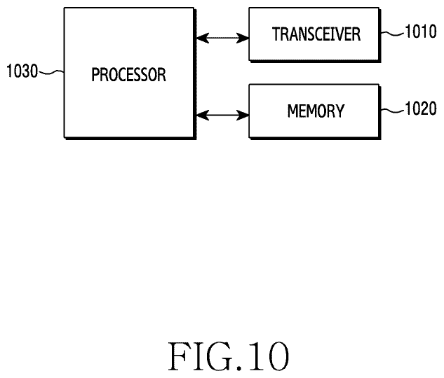

FIG. 10 illustrates various hardware components of a network entity according to the embodiments as disclosed herein. Furthermore, the network entity of FIG. 10 corresponds to the network entity referred to above according to various embodiments of the present disclosure.

Referring to FIG. 10, the network entity includes a transceiver (1010), a memory (1020), and a processor (1030). The transceiver (1010), the memory (1020), and the processor (1030) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (1030), the transceiver (1010), and the memory (1020) may be implemented as a single chip. Also, the processor (1030) may include at least one processor.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (1010) collectively refers to a network entity receiver and a network entity transmitter, and may transmit/receive a signal to/from a base station or a UE. The signal transmitted or received to or from the base station or the UE may include control information and data. In this regard, the transceiver (1010) may include an RF transmitter for up-converting and amplifying a frequency of a transmitted signal, and an RF receiver for amplifying low-noise and down-converting a frequency of a received signal. However, this is only an example of the transceiver (1010) and components of the transceiver (1010) are not limited to the RF transmitter and the RF receiver.

The transceiver (1010) may receive and output, to the processor (1030), a signal through a wireless channel, and transmit a signal output from the processor (1030) through the wireless channel.

The memory (1020) may store a program and data required for operations of the network entity. Also, the memory (1020) may store control information or data included in a signal obtained by the network entity. The memory (1020) may be a storage medium, such as a ROM, a RAM, a hard disk, a CD-ROM, and a DVD, or a combination of storage media.

The processor (1030) may control a series of processes such that the network entity operates as described above. For example, the transceiver (1010) may receive a data signal including a control signal, and the processor (1030) may determine a result of receiving the data signal.

The embodiments disclosed herein describe a systems and methods for managing network slice selection assistance information (NSSAI) lists in wireless communication networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high-speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the present disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a network entity, a downlink non-access stratum (DL NAS) message; and
deleting a stored partially allowed network slice selection assistance information (NSSAI) based on the DL NAS message,
wherein the DL NAS message comprises at least one of a CONFIGURATION UPDATE COMMAND message, or a REGISTRATION ACCEPT message.

2. The method of claim 1, wherein the deleting is performed, in case that the CONFIGURATION UPDATE COMMAND message includes a registration requested bit of a configuration update indication information element (IE) set to registration requested and the CONFIGURATION UPDATE COMMAND message contains no other parameters.

3. The method of claim 1, wherein the deleting is performed in case that the REGISTRATION ACCEPT message includes a network slice-specific authentication and authorization (NSSAA) to be performed indicator of a 5GS registration result IE set to Network slice-specific authentication and authorization is to be performed and the REGISTRATION ACCEPT message contains a pending NSSAI and no new partially allowed NSSAI.

4. The method of claim 1, wherein the DL NAS includes a new configured NSSAI, and
wherein the deleting is performed when the CONFIGURATION UPDATE COMMAND message contains a configuration update indication IE with a registration requested bit set to registration requested without any new allowed NSSAI.

5. The method of claim 1, wherein the DL NAS includes a new partially allowed NSSAI for a public land mobile network (PLMN) or a standalone non-public network (SNPN), and
wherein the method further comprises: removing, based on the new partially allowed NSSAI, one or more single network slice selection assistance information (S-NSSAI)s from at least one of a stored rejected NSSAI or a stored pending NSSAI.

6. The method of claim 5, wherein removing the one or more S-NSSAIs from the stored rejected NSSAI comprises, removing, from the stored rejected NSSAI for a current PLMN or SNPN, at least one of: a rejected NSSAI for a current registration area, a rejected NSSAI for a maximum number of UEs reached, or a partially rejected NSSAI, S-NSSAIs, if any, included in the new partially allowed NSSAI for the current PLMN or SNPN.

7. The method of claim 5, wherein removing the one or more S-NSSAIs from the stored rejected NSSAI comprises removing, from the stored rejected NSSAI for a failed or revoked NSSAA, the S-NSSAIs, if any, included in the new partially allowed NSSAI for a current PLMN if the UE is not roaming, or a current SNPN if the SNPN is a subscribed SNPN or a non-subscribed SNPN.

8. The method of claim 5, wherein removing the one or more S-NSSAIs from the stored pending NSSAI comprises, removing, from the stored pending NSSAI for the current PLMN and its equivalent PLMNs in the registration area or the current SNPN, one or more S-NSSAIs, if any, included in the new partially allowed NSSAI for the current PLMN and an equivalent PLMNs if the UE is not roaming, or the current SNPN if the SNPN is a subscribed SNPN or a non-subscribed SNPN.

9. The method of claim 1, wherein the network entity comprises an access and mobility management function (AMF) entity.

10. A method performed by an access and mobility management function (AMF) entity in a wireless communication system, the method comprising:
transmitting, to a user equipment (UE), a downlink non-access stratum (DL NAS) message; and
receiving, from the UE, a response signaling message comprising information about a single network slice selection assistance information (S-NSSAI(s)) part of the new partially allowed network slice selection assistance information (NSSAI) from stored NSSAI which is deleted by the UE for AMF entity on determining the new partially allowed NSSAI for a current public land mobile network (PLMN) or a current standalone non-public network (SNPN) is received from the AMF entity as part of the DL NAS message.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a network entity, a downlink non-access stratum (DL NAS) message; and
delete a stored partially allowed network slice selection assistance information (NSSAI) based on the DL NAS message,
wherein the DL NAS message comprises at least one of a CONFIGURATION UPDATE COMMAND message, or a REGISTRATION ACCEPT message.

12. The UE of claim 11, wherein the deleting is performed, in case that the CONFIGURATION UPDATE COMMAND message includes a registration requested bit of a configuration update indication information element (IE) set to registration requested and the CONFIGURATION UPDATE COMMAND message contains no other parameters.

13. The UE of claim 11, wherein the deleting is performed in case that the REGISTRATION ACCEPT message includes a network slice-specific authentication and authorization (NSSAA) to be performed indicator of a 5GS registration result IE set to Network slice-specific authentication and authorization is to be performed and the REGISTRATION ACCEPT message contains a pending NSSAI and no new partially allowed NSSAI.

14. The UE of claim 11, wherein the DL NAS includes a new configured NSSAI, and
wherein the deleting is performed when the CONFIGURATION UPDATE COMMAND message contains a configuration update indication IE with a registration requested bit set to registration requested without any new allowed NSSAI.

15. The UE of claim 11, wherein the DL NAS includes a new partially allowed NSSAI for a public land mobile network (PLMN) or a standalone non-public network (SNPN), and
wherein the instructions further cause the UE to: remove, based on the new partially allowed NSSAI, one or more single network slice selection assistance information (S-NSSAI)s from at least one of a stored rejected NSSAI or a stored pending NSSAI.

16. The UE of claim 15, wherein removing the one or more S-NSSAIs from the stored rejected NSSAI comprises, removing, from the stored rejected NSSAI for a current PLMN or SNPN, at least one of: a rejected NSSAI for a current registration area, a rejected NSSAI for a maximum number of UEs reached, or a partially rejected NSSAI, S-NSSAIs, if any, included in the new partially allowed NSSAI for the current PLMN or SNPN.

17. The UE of claim 15, wherein removing the one or more S-NSSAIs from the stored rejected NSSAI comprises removing, from the stored rejected NSSAI for a failed or revoked NSSAA, the S-NSSAIs, if any, included in the new partially allowed NSSAI for a current PLMN if the UE is not roaming, or a current SNPN if the SNPN is a subscribed SNPN or a non-subscribed SNPN.

18. The UE of claim 15, wherein removing the one or more S-NSSAIs from the stored pending NSSAI comprises, removing, from the stored pending NSSAI for the current PLMN and its equivalent PLMNs in the registration area or the current SNPN, one or more S-NSSAIs, if any, included in the new partially allowed NSSAI for the current PLMN and an equivalent PLMNs if the UE is not roaming, or the current SNPN if the SNPN is a subscribed SNPN or a non-subscribed SNPN.

19. The UE of claim 11, wherein the network entity comprises an access and mobility management function (AMF) entity.

20. An access and mobility management function (AMF) entity comprising:
at least one processor; and
at least one memory, communicatively coupled to the at least one processor, storing instructions executable by the at least one processor individually or in any combination to cause the AMF entity to:
transmit, to a user equipment (UE), a downlink non-access stratum (DL NAS) message, and
receive, from the UE, a response signaling message comprising information about a single network slice selection assistance information (S-NSSAI(s)) part of the new partially allowed network slice selection assistance information (NSSAI) from stored NSSAI which is deleted by the UE for AMF entity on determining the new partially allowed NSSAI for a current public land mobile network (PLMN) or a current standalone non-public network (SNPN) is received from the AMF entity as part of the DL NAS message.
